(19) United States
(12) Patent Application Publication
(10) Pub. No.: US 2019/0329339 A1
(43) Pub. Date: Oct. 31, 2019

(54) APPARATUS FOR GRINDING MACHINING OF GEAR WHEEL WORKPIECES

(71) Applicant: Klingelnberg GmbH, Huckeswagen (DE)

(72) Inventor: Hartmuth Müller, Remscheid (DE)

(21) Appl. No.: 16/392,932

(22) Filed: Apr. 24, 2019

(30) Foreign Application Priority Data
Apr. 25, 2018 (DE) 202018102298.9

(51) Int. Cl. B23F 1/02; B24B 5/04

(52) U.S. Cl. CPC B23F 1/02; B24B 5/047; B24B 5/045

(57) ABSTRACT

An apparatus comprising
a workpiece spindle for accommodating a gear wheel workpiece, wherein the gear wheel workpiece is rotationally drivable about a workpiece axis of rotation,
a first tool spindle for accommodating a first tool, wherein the first tool is rotationally drivable about a first tool axis of rotation, and comprising
multiple NC-controllable axes, which are designed to move the first tool in relation to the gear wheel workpiece so that tooth flanks of the gear wheel workpiece can be machined using the first tool,
a second tool spindle for accommodating a second tool, wherein the second tool is rotationally drivable about a second tool axis of rotation,
a linear carriage, which supports the second tool spindle and comprises an NC-controllable linear drive to be able to linearly displace the linear carriage along a linear guide in relation to the gear wheel workpiece.

### CROSS-REFERENCE TO RELATED APPLICATIONS

This application claims the benefit under 35 U.S.C. § 119(e) to the granted German utility patent DE202018102298.9 filed Apr. 25, 2018, which is hereby expressly incorporated by reference as part of the present disclosure.

### FIELD OF THE INVENTION

The present disclosure relates to an apparatus for grinding machining of gear wheel workpieces. For example, it relates to an apparatus for generating grinding of gear wheel workpieces.

### BACKGROUND

There are various methods for the gear cutting of gear wheel workpieces and for the (finish) machining of already previously gear-cut gear wheel workpieces. Classic gear wheels, for example, spur-toothed or helical-toothed spur gears, but also other gear wheel-type workpieces, for example, the elements or components of a cycloid gearing, are referred to here as gear wheel workpieces.

FIG. 1 shows a perspective view of a part of an apparatus 10 of the prior art (in the form of a NC-controlled gear wheel machine tool here), which is designed for the grinding of a gear wheel workpiece W. The apparatus 10 shown by way of example comprises a workpiece spindle 11 for accommodating/chucking a (previously gear-cut) gear wheel workpiece W, wherein the gear wheel workpiece W is rotationally drivable in the accommodated state about a workpiece axis of rotation B. Moreover, the apparatus comprises a tool spindle 12 for accommodating a tool 13, wherein the tool 13 is rotationally drivable in the accommodated state about a tool axis of rotation C1. In addition, there are multiple NC-controllable axes A, X, Y1, Z1, which are designed for the purpose of moving the tool 13 in the accommodated/chucked state in relation to the gear wheel workpiece W in such a way that tooth flanks of the gear wheel workpiece W can be machined using the tool 13.

The problem arises more and more frequently that a gear-cut gear wheel workpiece is to be provided with boreholes or other functional surfaces. These boreholes and other functional surfaces sometimes have to have a precisely specified position in relation to the gear teeth or in relation to one another. Such a requirement with respect to the position accuracy results, for example, in situations in which, for example, two gear wheels are to be connected to one another by a plug connection, or in which the elements or components of a cycloid gearing have to be connected to a drive axis in such a way that they can execute an eccentric rotational movement in relation to one another.

### SUMMARY

It is an object to provide an apparatus (or a gear wheel machine tool, respectively), which enables the boreholes and/or other functional surfaces to be machined on a gear wheel workpiece with high efficiency and precision.

An apparatus according to at least some embodiments comprises

a workpiece spindle for accommodating/chucking a (previously gear-cut) gear wheel workpiece, wherein the gear wheel workpiece is rotationally drivable about a workpiece axis of rotation in the accommodated state,

a first tool spindle for accommodating a first (grinding) tool, wherein the first (grinding) tool is rotationally drivable in the accommodated state about a first tool axis of rotation,

multiple NC-controllable axes, which are designed to move the first (grinding) tool in the accommodated/chucked state in relation to the gear wheel workpiece in the accommodated/chucked state in such a way that tooth flanks of the gear wheel workpiece can be machined using the first (grinding) tool.

The apparatus is distinguished in that it additionally comprises:

a second tool spindle for accommodating/chucking a second (grinding) tool, wherein the second (grinding) tool is rotationally drivable in the accommodated/chucked state about a second tool axis of rotation,

a linear carriage, which supports the second tool spindle and which comprises an NC-controllable linear drive to be able to linearly displace the linear carriage along a linear guide in relation to the gear wheel workpiece in the accommodated/chucked state.

In at least some of embodiments, the apparatus is designed for grinding machining of the tooth flanks of the bevel gear workpiece and for grinding (fine) machining of walls of boreholes and/or functional surfaces, which are located in the region of an end face of the gear wheel workpiece.

In at least some embodiments, the apparatus is designed for generating grinding of the gear wheel workpiece, wherein it comprises at least five NC-controllable axes, which are designed for moving the first (grinding) tool in relation to the gear wheel workpiece, and wherein a worm grinding wheel is used as the first (grinding) tool.

In at least some embodiments, the first tool spindle is associated with three linear axes and one pivot axis, and the second tool spindle is associated with the NC-controllable linear drive, the second tool axis of rotation, and an additional linear axis.

In at least some embodiments, the apparatus comprises at least

one first workpiece axis of rotation, to be able to rotationally drive the gear wheel workpiece,

a first tool axis of rotation, to be able to rotationally drive the first (grinding) tool,

a second tool axis of rotation, to be able to rotationally drive the second (grinding) tool,

a first NC-controllable axis, which enables a linear movement of the first (grinding) tool in parallel to the workpiece axis of rotation in relation to the gear wheel workpiece,

a second NC-controllable axis, which enables a linear movement of the second (grinding) tool parallel to the workpiece axis of rotation in relation to the gear wheel workpiece,

a third NC-controllable axis, which enables a linear movement of the second (grinding) tool perpendicular to the workpiece axis of rotation in relation to the gear wheel workpiece, wherein this third NC-controllable axis may comprise an NC-controllable linear drive.

In at least some embodiments, the apparatus comprises

two independently controllable linear axes, which enable movements of the first tool parallel to a y axis of a Cartesian coordinate system and movements of the second tool parallel to the same y axis,

two independently controllable linear axes, which enable movements of the first tool parallel to a z axis of the Cartesian coordinate system and movements of the second tool parallel to the same z axis, wherein the linear axis which is associated with the second tool is movable by the NC-controllable linear drive.

To be able to fine machine the walls of boreholes and other functional surfaces, a grinding wheel, a cylindrical grinding body, or a grinding body in the form of a truncated cone is used as the second tool, wherein this tool is rotationally drivable via a shaft about the second tool axis of rotation.

In at least some embodiments, the apparatus may comprise an NC-controller, or it is connectable to an NC-controller, wherein this NC-controller is designed to execute movements of the axes of the apparatus with great precision.

In at least some embodiments, an NC controller is used which is designed to execute coupled movements of the gear wheel workpiece about the workpiece axis of rotation and the NC-controllable linear drive of the second tool, to enable grinding machining of walls of holes, boreholes, and recesses which are located in the region of an end face of the gear wheel workpiece.

In at least some embodiments of the apparatus, both the machining of the tooth flanks of the gear wheel workpiece and also the grinding (fine) machining of the walls of boreholes and functional surfaces take place in one chucking of the gear wheel workpiece, i.e., the gear wheel workpiece does not have to be re-chucked.

This summary is not exhaustive of the scope of the aspects and embodiments of the invention. Thus, while certain aspects and embodiments have been presented and/or outlined in this summary, it should be understood that the inventive aspects and embodiments are not limited to the aspects and embodiments in this summary. Indeed, other aspects and embodiments, which may be similar to and/or different from, the aspects and embodiments presented in this summary, will be apparent from the description, illustrations and/or claims, which follow, but in any case are not exhaustive or limiting. Further details can be inferred from the various embodiments which are described hereafter.

It should also be understood that any aspects and embodiments that are described in this summary and elsewhere in this application and do not appear in the claims that follow are preserved for later presentation in this application or in one or more continuation patent applications.

### BRIEF DESCRIPTION OF THE DRAWINGS

Other advantages and features will become apparent from the following detailed description, which are to be understood not to be limiting, and are described in more detail below with reference to the drawings.

FIG. 1 schematically shows a perspective view of a part of an apparatus (in the form of an NC-controlled gear wheel machine tool here), which is designed for the grinding of a gear wheel workpiece;

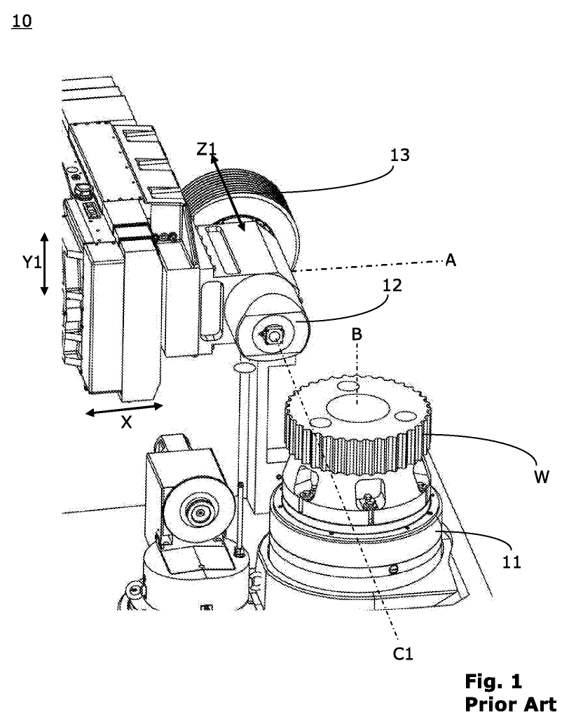

FIG. 2 schematically shows a perspective view of a part of an apparatus (in the form of an NC-controlled gear wheel machine tool here) for the grinding of a gear wheel workpiece and for the grinding of boreholes and other functional surfaces of the gear wheel workpiece;

FIG. 3 schematically shows a perspective view of a gear wheel workpiece which has two lateral boreholes and one central borehole in the region of an upper end face, which were machined;

FIG. 4 schematically shows a perspective view of a part of an apparatus, which comprises a grinding apparatus for grinding boreholes and other functional surfaces of the gear wheel workpiece;

FIG. 5 schematically shows an enlarged top view of a borehole located in the inside of a gear wheel workpiece.

### DETAILED DESCRIPTION

Terms, which are also used in relevant publications and patents, are used in conjunction with the present description. However, it is to be noted that the use of these terms is merely to serve for better comprehension. The inventive concepts and the scope of protection of the patent claims are not to be restricted in the interpretation by the specific selection of the terms. The details presented herein may be readily transferred to other term systems and/or technical fields. The terms are to be applied accordingly in other technical fields.

A hole having circular cross-section is referred to here as a borehole, even if this borehole was not drilled using a drill. Boreholes can also be produced in another manner—for example, by milling, laser machining, a high-pressure water jet machining, or by a casting method.

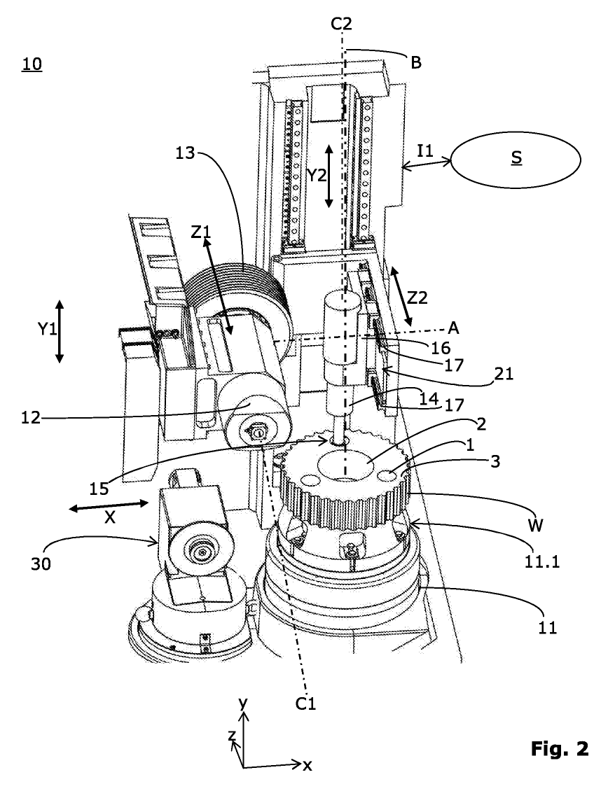

An axis is referred to here as an NC-controllable axis, the movements of which are controllable monitored by an NC-controller S (see FIG. 2). For this purpose, an NC-controllable axis comprises, for example, a drive, which is associated with this axis, and at least one sensor or a monitoring means (for example, an angle decoder), to detect an actual position of the axis and compare it to a target position. The NC controller S can control the drive of the NC-controllable axis by way of an actual-target comparison so that a suitable movement is executed.

At least some embodiments relate to an apparatus or gear wheel machine tool 10, respectively, which comprises at least 5 NC-controllable axes to enable 5-axis grinding machining of a gear wheel workpiece W.

At least some of the embodiments relate to an apparatus or gear wheel machine tool 10 for grinding the tooth flanks of a gear wheel workpiece W. In this case, a grinding tool is used as the first tool 13.

At least a some embodiments relate to an apparatus or gear wheel machine tool 10, respectively, for grinding of the tooth flanks of a gear wheel workpiece W. In this case, the grinding comprises the profile grinding of a gear wheel workpiece W using a profile grinding wheel and/or the continuous grinding of a gear wheel workpiece W using a worm grinding wheel 13, as shown in FIG. 2. In gear wheel machine tools 10 which are designed for the grinding of gear wheel workpieces W, at least 6 NC-controllable axes are used.

The apparatus or the gear wheel machine tool 10 comprises a dressing device 30 (see FIG. 2), which is arranged and designed so that the profile grinding wheel or the worm grinding wheel 13 can be dressed precisely.

FIG. 2 shows the perspective view of a part of an apparatus 10, in the form of a gear wheel machine tool here, for grinding. This apparatus 10 is equipped in this embodiment a workpiece spindle 11 for accommodating (chucking) a gear wheel workpiece W. The chucking means 11.1, which enable the gear wheel workpiece W to be chucked, are shown by way of example in FIG. 2. There are numerous possibilities for implementing such chucking means 11.1, therefore only one possible variant is shown here. The workpiece spindle 11 is designed so that the gear wheel workpiece W is rotationally drivable about a workpiece axis of rotation B in the accommodated/chucked state. For this purpose, a rotational drive is associated with the workpiece spindle 11, which is not shown in FIG. 2. This rotational drive or the workpiece axis of rotation B is an NC-controllable axis in at least some embodiments, since one precisely controlled rotation capability of the gear wheel workpiece W is important in conjunction with the precisely controlled movements of a second grinding tool 15, as will be explained hereafter.

The workpiece axis of rotation B is perpendicular in space in at least some embodiments (the workpiece axis of rotation B extends parallel to the y axis of a Cartesian x-y-z coordinate system here, which is shown in FIG. 2).

The apparatus 10 furthermore comprises a first tool spindle 12, which is designed for accommodating/chucking a first (grinding) tool 13 (in the form of a worm grinding wheel suitable for generating grinding here). The first tool spindle 12 is designed so that the first (grinding) tool 13 is rotationally drivable about a first tool axis of rotation C1 in the accommodated/chucked state. For this purpose, a rotational drive, which is not shown in FIG. 2, is associated with this tool spindle 12. This rotational drive or the first tool axis of rotation C1, respectively, can be an NC-controllable axis. The first tool axis of rotation C1 extends horizontally at the moment shown, but can also be pivoted about a pivot axis A to be able to adapt the inclination of the worm grinding wheel in accordance with the pitch of its teeth to the position of the tooth flanks of the gear wheel workpiece W. In FIG. 2, the pivot axis A is only indicated. It extends parallel to the x axis of the x-y-z coordinate system.

In addition to the above-mentioned axes B, C1, and A, the apparatus 10 comprises further NC-controllable axes. In the exemplary embodiment of FIG. 2, these are the three linear axes X, Y1, and Z1. The use of the capital letters X, Y, Z is to indicate that these axes extend in parallel to the corresponding axes of the Cartesian x-y-z coordinate system provided with lowercase letters.

Other constellations of the NC-controllable axes are also possible. The constellation of the NC-controllable axes is selected so that the first tool 13 can be moved in the accommodated/chucked state in relation to the gear wheel workpiece W in the accommodated/chucked state so that the tooth flanks of the gear wheel workpiece W can be machined by grinding using the first tool 13.

The coordination of the movement sequences and the coupling of the movements is performed by means of an NC-controller S, which can be connected, for example, via a communication connection I1 to the drives, sensors, and control means of the apparatus 10. The NC controller S can be a component of the apparatus 10 in at least some embodiments, however, it can also be designed as an external controller, which is connectable for communication to the apparatus 10.

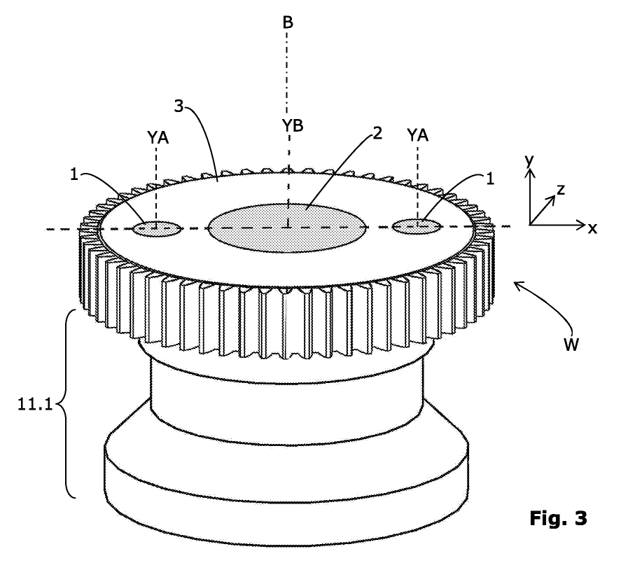

It can be seen in FIG. 2 that the gear wheel workpiece W comprises three outer boreholes 1 (having a radial distance to the workpiece axis of rotation B) and one central borehole 2 on its upper end face 3. In the example shown, these are cylindrical boreholes, the central borehole axes of which (see also FIG. 3) extend parallel to the y axis.

Further aspects will now be described on the basis of FIG. 3, which shows details of another gear wheel workpiece W. The upper end face 3 of a gear wheel workpiece W can be seen in FIG. 3. The upper end face 3 lies in a plane which extends parallel to the x-z plane of the coordinate system. One central borehole 2 and two additional outer boreholes 1 are shown in the example of FIG. 3. The central borehole axes, which extend parallel to the y axis, are identified by the reference signs YA and YB. The borehole axes YA and YB were shown here to indicate that the walls of the boreholes 1, 2 also extend parallel to the workpiece axis of rotation B.

Within certain limits, it is also possible using the apparatus 10 to machine the walls of boreholes 1 and other functional surfaces which extend slightly inclined in relation to the plane of the end face 3. In this case, a grinding wheel may be used as the second grinding tool 15 which is relatively thin (observed parallel to the y axis) or a grinding body in the form of a truncated cone is used, which is coated at least in the region of the largest diameter d2 so that material of the gear wheel workpiece W can be abraded.

In at least some embodiments, the second grinding tool 15 can be coated using CBN abrasive grains (CBN stands for cubic boron nitride).

To be able to finely machine such boreholes 1, 2 and other functional surfaces in the region of an upper end face 3 of a gear wheel workpiece W precisely, the apparatus may be based on path-controlled grinding machining using a rotationally-driven grinding tool, which is referred to here as the second (grinding) tool 15. It can be seen on the basis of FIGS. 2 and 3 that only little space is available for such a second tool 15, since the tool 15 has to be capable of penetrating into the boreholes 1, 2 and other functional surfaces to machine the walls thereof.

As shown in FIG. 2, the apparatus 10, in addition to the above-described elements, comprises a second tool spindle 14 for accommodating/chucking the second (grinding) tool 15. Because a second tool spindle 14 having a second (grinding) tool 15 is provided on the apparatus 10, the boreholes 1, 2 and other functional surfaces can be machined with high accuracy, without the gear wheel workpiece W having to be re-chucked. Since re-chucking of the gear wheel workpiece W is omitted, the grinding machining of the boreholes 1, 2 and other functional surfaces can be performed in such a way that they are located in a precisely specified position in relation to the tooth flanks previously machined by grinding. Moreover, it is possible, for example, to ensure the position accuracy of the boreholes 1 in relation to the central borehole 2, i.e., the relative position accuracy can be ensured by the special equipment of the apparatus 10.

The second tool spindle 14 is designed so that the second (grinding) tool 15 is rotationally drivable about a second tool axis of rotation C2 in the accommodated/chucked state. For this purpose, a rotational drive, which is not shown in FIG. 2, is associated with this tool spindle 14. This rotational drive or the second tool axis of rotation C2, respectively, can be designed as NC-controllable, but does not have to be. For grinding machining of the walls of the holes/boreholes and other recesses, a rotational drive which ensures a sufficiently high speed (for example, of at least 25,000 RPM) is often sufficient.

To be able to grind the walls of boreholes 1, 2 and other functional surfaces with high precision, a path controller of the relative movement sequences is used. To enable the corresponding relative movement in three-dimensional space, the apparatus 10 comprises two linear axes, which are referred to here as the Y2 and Z2 axes, in at least some embodiments. Moreover, the second tool axis of rotation C2 has the above-mentioned NC-controlled or non-NC-controlled rotational drive.

The corresponding relative movements in three-dimensional space are monitored and controlled by the NC controller S, wherein—while the second (grinding) tool 15 rotates at a high speed about the tool axis of rotation C2—at least the Z2 axes are driven linearly, and the workpiece axis of rotation B is driven to rotate. From a superposition of the linear movement of the Z2 axes and the rotational movement of the gear wheel workpiece W about the workpiece axis of rotation B, the walls of the boreholes 1, 2 and the other functional surfaces can be ground with high precision in all the regions thereof. If a depth infeed parallel to the y axis is necessary, the Y2 axis is also used.

In the specific axis constellation shown in FIG. 2, the linear movement of the Y2 axis, which extends parallel to the y axis, is used for the depth infeed of the second (grinding) tool 15. The linear movement of the Z2 axis, which extends parallel to the z axis, enables, in coupled cooperation with the rotational movement of the gear wheel workpiece W about the workpiece axis of rotation B, machining of all regions of the walls.

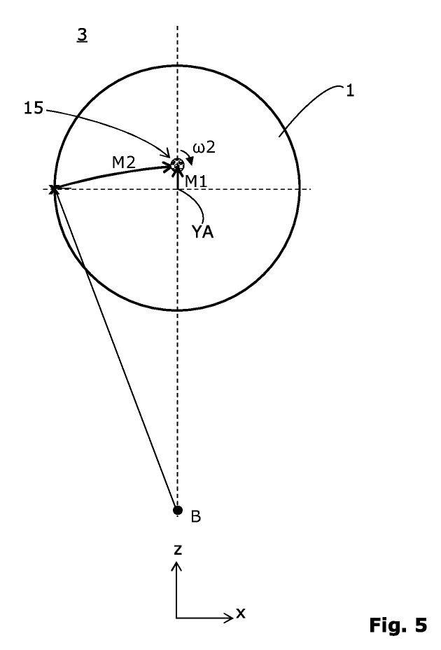

The coupled cooperation of a rotational movement of the gear wheel workpiece W about the workpiece axis of rotation B and a linear movement of the Z2 axis will be explained on the basis of an enlarged view of a borehole 1 and several geometric specifications in conjunction with FIG. 5. The borehole 1 has a circular cross section in the x-z plane and a radial spacing from the workpiece axis of rotation B (the radial spacing is defined here by the distance B-YA). The circle center point of the cross section of the borehole 1 is defined here by the drilling axis YA, which extends parallel to the workpiece axis of rotation B. To be able to illustrate the geometrical relationships more clearly, the circular cross section of a grinding tool 15 having a very small diameter d2 is shown in FIG. 5. Moreover, the center point of the gear wheel workpiece W is shown as the passage point of the workpiece axis of rotation B in FIG. 5 by a small black dot.

The movements M1 and M2 shown schematically and by way of example in FIG. 5 can be executed successively or simultaneously.

To be able to move toward a point X of the wall of the hole 1 and grind it using the grinding tool 15 (wherein a two-dimensional observation in the x-z plane is presumed here), in the example shown, the two movements M1 and M2 are executed, wherein a starting position of the grinding tool 15 in the center point of the borehole 1 is presumed in the example shown. A linear movement M1 is executed to displace the grinding tool 15 along the z axis proceeding from the center point. This linear movement M1 is generated by the control of the Z2 axis. Since the grinding tool can only execute movements of the Z2 axis and depth infeeds parallel to the Y2 axis, it is not possible to pivot the grinding tool 15 in the direction of the wall. Therefore, in an apparatus 10 of FIG. 2, the gear wheel workpiece W is pivoted clockwise somewhat about the B axis (workpiece axis of rotation B). This pivot of the gear wheel workpiece W is shown in FIG. 5 by the curved arrow M2. The curvature of the curved arrow M2 is determined by the radius which results from the distance B-X.

The apparatus 10 can approach any point (for example, the point X shown in FIG. 5) of the wall of the borehole 1 with pinpoint accuracy by way of movements which are correspondingly coupled, i.e., adapted to one another. In the example shown, the grinding tool 15 is rotationally driven clockwise. This rotational movement, which is indicated in FIG. 5 with the reference sign ω2, takes place about the C2 axis.

In at least some embodiments, the apparatus 10 comprises a linear carriage 16, which supports the second tool spindle 14 and comprises an NC-controllable linear drive 21. This linear carriage 16 is linearly displaceable along two linear guides 17 (which extend parallel to the z axis here) in relation to the gear wheel workpiece W in the accommodated/chucked state. Due to the use of a linear carriage 16 having NC-controllable linear drive 21, the second (grinding) tool 15 can be moved parallel to the z axis with high precision and without recognizable hysteresis.

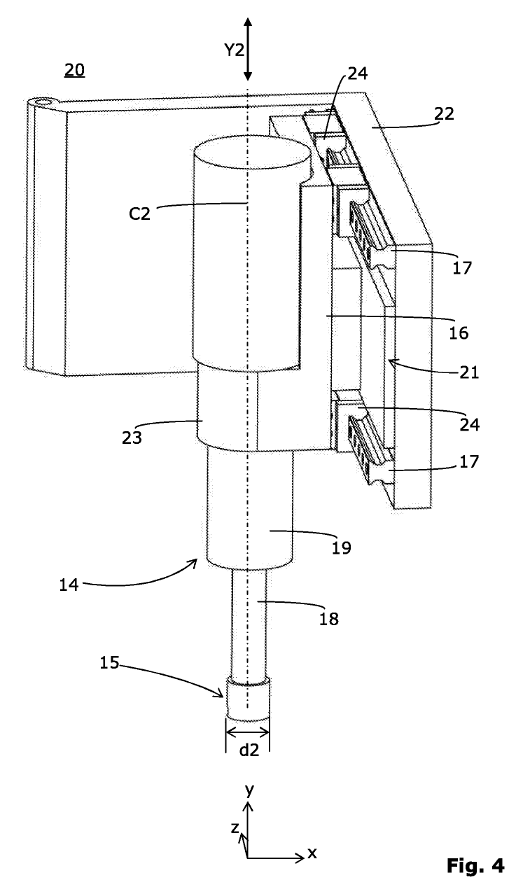

Details of an embodiment of a grinding apparatus 20, which can be used in at least some embodiments, are shown in a perspective view in FIG. 4. The grinding apparatus 20 comprises, as already mentioned, a linear carriage 16, which is mounted so it is displaceable along linear guides 17. The linear guides 17 are shown in the form of rails, which are fastened on a vertical plate 22 of the apparatus 10. The vertical plate 22 can optionally be linearly displaced in parallel to the y axis in correspondingly designed embodiments (the corresponding axis was already previously identified and described as the Y2 axis). Carriage elements 24, which enclose the rails, are provided in pairs on the linear carriage 16. The linear carriage 16 can be linearly moved in parallel to the z axis by activating a linear drive 21. Details of the linear drive 21 are not recognizable in FIG. 4, since they are integrated in the region of the stationary rails and the carriage elements 24.

A mount 23, which encloses a cylindrical housing 19 of the second tool spindle 14, is provided on the linear carriage 16. The tool spindle 14 has a shaft 18 here, which enables the grinding apparatus 20 to plunge as deeply as possible into one of the boreholes 1, 2. The second (grinding) tool 15 is chucked at the lower end of the shaft 18 so that it may be rotationally driven together with the shaft 18 about the second tool axis of rotation C2. A relative depth infeed of the grinding apparatus 20 is enabled by the activation of the Y2 axis of the apparatus 10 (see FIG. 2). A relative horizontal movement is enabled by the control of the Z2 axis of the apparatus 10 or the grinding apparatus 20, respectively (see FIGS. 2 and 4).

A cylindrical grinding body 15 is shown as a (grinding) tool in FIG. 4. The diameter d2 of this grinding body 15 is selected so that the grinding wheel 15 can plunge without problems into the boreholes 1, 2. The grinding body 15 is coated so that material of the gear wheel workpiece W is abraded when a sufficiently large cutting speed results on the wall to be ground because of the rapid rotational movement of the grinding wheel 15 about the tool axis of rotation C2.

To give the (grinding) tool 15 corresponding freedom of movement in the interior of boreholes or in the region of other functional surfaces, the diameter d2 is selected so that it is at most 80% of the diameter of the borehole 1, 2 to be ground.

In contrast to what is shown in FIG. 4, the grinding apparatus 20 can also have a driveshaft located in a hollow cylinder. In such embodiments, the driveshaft including the (grinding) tool 15 is rotationally driven, while the hollow cylinder does not rotate.

While the above describes certain embodiments, those skilled in the art should understand that the foregoing description is not intended to limit the spirit or scope of the present disclosure. It should also be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure.

What is claimed is:

1. An apparatus comprising:
a workpiece spindle configured to receive a gear wheel workpiece, wherein the gear wheel workpiece is rotationally drivable about a workpiece axis of rotation when received by the workpiece spindle;
a first tool spindle configured to receive a first tool, wherein the first tool is rotationally drivable about a first tool axis of rotation when received by the first tool spindle;
multiple NC-controllable axes configured to move the first tool when received by the first tool spindle relative to the gear wheel workpiece when received by the workpiece spindle for machining tooth flanks of the gear wheel workpiece with the first tool;
a second tool spindle configured to receive a second tool, wherein the second tool is rotationally drivable about a second tool axis of rotation when received by the second tool spindle; and
a linear carriage configured to support the second tool spindle and comprising an NC-controllable linear drive configured to linearly displace the linear carriage along a linear guide relative to the gear wheel workpiece when received by the workpiece spindle.

2. An apparatus according to claim 1, wherein the apparatus is configured for grinding machining tooth flanks of the gear wheel workpiece, and for grinding machining walls of boreholes and functional surfaces located at or near an end face of the gear wheel workpiece.

3. An apparatus according to claim 1, wherein the multiple NC-controllable axes include at least six NC-controllable axes configured to move the first tool relative to the gear wheel workpiece, and wherein the first tool defines a worm grinding wheel.

4. An apparatus according to claim 1, wherein
the first tool spindle is operatively connected or connectable to three linear axes and one pivot axis of the multiple NC-controlled axes, and
the second tool spindle is operatively connected or connectable to the NC-controllable linear drive, the second tool axis of rotation, and an additional linear axis.

5. An apparatus according to claim 1, further comprising
a first additional linear axis; and
a second additional linear axis;
wherein a first of the multiple NC-controllable axes and the first additional linear axis are independently activatable linear axes and configured to move the first tool parallel to a y axis of a Cartesian coordinate system and the second tool parallel to said y axis, and
a second of the multiple NC-controllable axes and the second additional linear axis are independently activatable linear axes and configured to move the first tool parallel to a z axis of the coordinate system and the second tool parallel to said z axis, wherein the second additional linear axis is operatively connected or connectable to the second tool and the NC-controllable linear drive is configured to drive the second additional linear axis.

6. An apparatus according to claim 1, wherein
one of the multiple NC-controllable axes is configured to move the first tool parallel to the workpiece axis of rotation;
one of the multiple NC-controllable axes is configured to linearly move the second tool parallel to the workpiece axis of rotation; and
the linear carriage is configured to linearly move the second tool perpendicular to the workpiece axis of rotation.

7. An apparatus according to claim 1, wherein the second tool defines a grinding wheel, a cylindrical grinding body, or a truncated cone-shaped grinding body, and wherein the second tool is rotationally drivable by a shaft about the second tool axis of rotation.

8. An apparatus according to claim 1, wherein the apparatus is connectable to or comprises an NC-controller, wherein said NC-controller is configured to drive the workpiece axis of rotation and the multiple NC-controllable axes.

9. An apparatus according to claim 8, wherein the NC-controller is configured to coupledly drive the gear wheel workpiece about the workpiece axis of rotation and move the NC-controllable linear drive for grinding machining, with the second tool, of walls of boreholes and functional surfaces located at or near an end face of the gear wheel workpiece.

10. An apparatus according to claim 2, wherein the multiple NC-controllable axes include at least six NC-controllable axes configured to move the first tool relative to the gear wheel workpiece, and wherein the first tool defines a worm grinding wheel.

11. An apparatus according to claim 2, wherein
the first tool spindle is operatively connected or connectable to three linear axes and one pivot axis of the multiple NC-controlled axes, and
the second tool spindle is operatively connected or connectable to the NC-controllable linear drive, the second tool axis of rotation, and an additional linear axis.

12. An apparatus according to claim 2, further comprising
a first additional linear axis; and
a second additional linear axis;
wherein a first of the multiple NC-controllable axes and the first additional linear axis are independently activatable linear axes and configured to move the first tool parallel to a y axis of a Cartesian coordinate system and the second tool parallel to said y axis, and
a second of the multiple NC-controllable axes and the second additional linear axis are independently activatable linear axes and configured to move the first tool parallel to a z axis of the coordinate system and the second tool parallel to said z axis, wherein the second additional linear axis is operatively connected or connectable to the second tool and the NC-controllable linear drive is configured to drive the second additional linear axis.

13. An apparatus according to claim 2, wherein
one of the multiple NC-controllable axes is configured to move the first tool parallel to the workpiece axis of rotation;
one of the multiple NC-controllable axes is configured to linearly move the second tool parallel to the workpiece axis of rotation; and
the linear carriage is configured to linearly move the second tool perpendicular to the workpiece axis of rotation.

14. An apparatus according to claim 2, wherein the second tool defines a grinding wheel, a cylindrical grinding body, or a truncated cone-shaped grinding body, and wherein the second tool is rotationally drivable by a shaft about the second tool axis of rotation.

15. An apparatus according to claim 3, wherein the apparatus is configured for grinding the gear wheel workpiece.
